(19) United States
(12) Patent Application Publication
(10) Pub. No.: US 2003/0102337 A1
(43) Pub. Date: Jun. 5, 2003

(54) Internal impingement nozzle

(76) Inventor: Bradley P. Walter, Superior, CO (US)

Correspondence Address: Barnes & Thornburg, 11 S. Meridian Street, Indianapolis, IN, 46204, US

(21) Appl. No.: 10/176,194

(22) Filed: Jun. 20, 2002

Related U.S. Application Data
(60) Provisional application No. 60/338,611, filed on Dec. 3, 2001.

(51) Int. Cl. F23D 14/68; B05B 1/14; B65D 47/00; B67D 3/00

(52) U.S. Cl. 222/547

(57) ABSTRACT

An apparatus for dispensing a fluid includes a nozzle defining an orifice in a front face of the nozzle. The material is discharged through the orifice. The nozzle includes a flow divider cooperating to separate a supply of the material into two streams. The flow divider includes two surfaces which intersect not further forward in the nozzle than the front face.

### FIELD OF THE INVENTION

This invention relates to devices for the spraying of fluids. It is disclosed in the context of devices for the spraying of fluid resins, monomers, oligomers, or the like. As used here, oligomer means a polymer made up of a few monomer units so that it remains fluid However, it may be useful in other applications as well.

### BACKGROUND OF THE INVENTION

The application of gel coats or other pigmented resins, for example, in the production of finish surfaces on tubs, shower stalls, watercraft hulls, and many other articles, typically requires lower flow rates of these materials than those required to build Up the underlying structural layers of such articles. For example, external impingement tips designed for such flow rates typically have discharge orifice diameters in the range of about 0.018″-0.023″ (about 0.46 mm.-0.58 mm.). These orifices must be disposed in the plane of the spray with tolerances typically on are the order of about 0.001″-0.002″ (about 0.025 mm.-0.05 mm.) in order to develop a satisfactory spray pattern.

Several types of spray nozzles which use single orifice, undivided flows of material to produce relatively flat, “fan-shaped” sprays are known. Typically those nozzles require relatively high pressure delivery of the material to be sprayed in order to produce their characteristic flat, fan-shaped spray patterns. The use of high pressure, however, results in quite fine atomization and attendant overspray, atomized particles that do not reach the article to be coated, and thus are wasted. Additionally, fine atomization results in the release of considerable amounts of the carriers, such as volatile organic compounds, or VOCs, for the sprayed materials, such as liquid paints and resins. The release of VOCs raises workplace safety and environmental concerns, and thus is to be avoided wherever possible.

In an effort to avoid the use of high pressure in spraying of materials, the use of external impingement nozzles has been proposed. There are, for example, the systems described in U.S. Pat. Nos. 6,113,013 and 6,322,008 and the references cited in these two patents. No representation is intended by this listing that this is a complete listing of all pertinent prior art, or that a thorough search of all pertinent prior art has been conducted, or that no better prior art exists. Nor should any such representation be inferred.

In systems of the type described in these two patents, two separate coarse jets of the material to be sprayed are produced. These two jets are angled by the spray apparatus so that the jets impinge upon each other a distance in front of the spray apparatus. A more finely divided, fan-shaped spray of the material results beyond the point at which the two jets impinge upon each other. This spray pattern typically has heavy edge margins, making it less than completely satisfactory for applications requiring relatively uniform sprayed particle size distribution, without the application of auxiliary jets of air to the heavy-edged fan-shaped spray pattern.

Other proposals exist for the production of sprays. These include nozzles which produce non-intersecting jets of material, somewhat like the spray produced by a showerhead. Showerhead-type nozzles typically produce “striped” spray patterns. These spray patterns also often suffer from too-broad distribution of sprayed particle sizes to produce the results sometimes required in such applications.

### DISCLOSURE OF THE INVENTION

According to an aspect of the invention, an apparatus for dispensing a fluid includes a nozzle defining an orifice in a front face of the nozzle, through which orifice the material is discharged. The nozzle includes a flow divider cooperating to separate a supply of the material into two streams. The flow divider includes two surfaces which intersect not further forward in the nozzle than the front face.

Illustratively according to this aspect of the invention, the two surfaces make substantially equal angles adjacent the orifice to a longitudinal axis of the nozzle.

Further illustratively according to this aspect of the invention, the nozzle includes a first feature and the flow divider is formed as a separate component including a second feature. The first and second features cooperate to orient the intersection of the two surfaces with respect to the orifice.

Further illustratively according to this aspect of the invention, the nozzle includes a first feature and the flow divider includes a second feature cooperating with the first feature to orient the intersection of the two surfaces with respect to the orifice.

Additionally illustratively according to this aspect of the invention, the first feature includes a relief formed in a back side of the front face, and the second feature includes a region of the flow divider for orientation in the relief.

Illustratively according to this aspect of the invention, the angles are between 20 and 60 degrees. Angles less than 20 degrees and greater than 60 degrees are also useful.

Further illustratively according to this aspect of the invention, the angles are between 25 and 40 degrees. Angles less than 25 degrees and greater than 40 degrees are also useful.

Illustratively according to this aspect of the invention, the orifice is generally circular transverse to an axis of the nozzle.

Alternatively illustratively according to this aspect of the invention, the orifice is generally somewhat oval shaped or cat's eye shaped transverse to an axis of the nozzle. Other orifice shapes are also useful, for example, diamond shaped, elliptical, square, and so on.

Illustratively according to this aspect of the invention, the two surfaces include two flat surfaces. The surfaces may also be concave, convex or irregular.

According to another aspect of the invention, a method of dispensing a fluid includes impinging separate streams of the fluid against each other and substantially simultaneously ejecting the reunited stream through an orifice.

Illustratively according to this aspect of the invention, the method further includes dividing a flow of the fluid into the separate streams using a flow divider. Impinging the streams against each other includes impinging the streams against each other at a downstream end of the flow divider.

Illustratively according to this aspect of the invention, impinging the streams against each other at a downstream end of the flow divider includes providing on the flow divider separate surfaces across which the separate streams flow downstream from a point at which the flow divider divides the fluid into separate streams. The separate surfaces intersect each other no further downstream in the flow of the fluid than the orifice.

According to another aspect of the invention, an article is made by impinging separate streams of a fluid against each other and substantially simultaneously ejecting the reunited stream formed from the impinging streams through an orifice.

Illustratively according to this aspect of the invention, the article is made by dividing a curable fluid into the separate streams, impinging the streams against each other, substantially simultaneously ejecting the reunited streams through the orifice onto a surface having a complementary shape to a shape of the article, permitting the fluid to cure on the complementarily shaped surface, and removing the article from the surface.

Further illustratively according to this aspect of the invention, the article is made by dividing the fluid into separate streams using a flow divider, and impinging the streams against each other at a downstream end of the flow divider.

Additionally illustratively according to this aspect of the invention, the article is made by providing on the flow divider separate surfaces across which the separate streams flow downstream from a point at which the flow divider divides the fluid into separate streams. The separate surfaces intersect each other no further downstream in the flow of the fluid than the orifice.

According to yet another aspect of the invention, apparatus for dispensing a fluid includes means for dividing a flow of fluid into separate streams, means for impinging the separate streams against each other, and means for substantially simultaneously ejecting the reunited stream through an orifice.

Illustratively according to this aspect of the invention, the means for dividing the fluid into separate streams includes a flow divider, and the means for impinging the streams against each other includes impingement means at a downstream end of the flow divider.

Illustratively according to this aspect of the invention, the impingement means includes separate surfaces which intersect each other no further downstream in the flow of the fluid than the orifice.

### BRIEF DESCRIPTION OF THE DRAWINGS

The invention may best be understood by referring to the following detailed description and accompanying drawings which illustrate the invention. In the drawings:

FIG. 1 illustrates a perspective view of a flow divider insert for a nozzle for dispensing a sprayable material, such as a resin, constricted according to the present invention;

FIG. 2 illustrates a side elevational view of the flow divider illustrated in FIG. 1;

FIG. 3 illustrates a top or bottom plan view of the flow divider illustrated in FIGS. 1-2;

FIG. 4 illustrates a front elevational view of the flow divider illustrated in FIGS. 1-3;

FIG. 5 illustrates a perspective view of a nozzle for dispensing a sprayable material, constructed according to the present invention;

FIG. 6 illustrates a front elevational view of the nozzle illustrated in FIG. 5;

FIG. 7 illustrates a sectional side elevational view of the nozzle illustrated in FIGS. 5-6, taken generally along section lines 7-7 of FIG. 6;

FIG. 8 illustrates an enlarged view of a detail of FIG. 7;

FIG. 9 illustrates a plan view of the nozzle illustrated in FIGS. 5-8;

FIG. 10 illustrates a side elevational view of the nozzle illustrated in FIGS. 5-9;

FIG. 11 illustrates a rear (gun-side) elevational view of the nozzle illustrated in FIGS. 5-10;

FIG. 12 illustrates a perspective view of another nozzle constructed according to the present invention;

FIG. 13 illustrates a rear elevational view of the nozzle illustrated in FIG. 12;

FIG. 14 illustrates a sectional side elevational view of the nozzle illustrated in FIGS. 12-13, taken generally along section lines 14-14 of FIG. 13;

FIG. 15 illustrates a side elevational view of the nozzle illustrated in FIGS. 12-14;

FIG. 16 illustrates a perspective view of another nozzle constructed according to the present invention;

FIG. 17 illustrates a rear elevational view of the nozzle illustrated in FIG. 16;

FIG. 18 illustrates a sectional side elevational view of the nozzle illustrated in FIGS. 16-17, taken generally along section lines 18-18 of FIG. 17;

FIG. 19 illustrates a side elevational view of the nozzle illustrated in FIGS. 16-18;

FIG. 20 illustrates a perspective view of a another flow divider insert constructed according to the present invention;

FIG. 21 illustrates a side elevational view of the flow divider illustrated in FIG. 20;

FIG. 22 illustrates a plan view of the flow divider illustrated in FIGS. 20-21;

FIG. 23 illustrates a front elevational view of the flow divider illustrated in FIGS. 20-22;

FIG. 24 illustrates a perspective view of another nozzle constructed according to the present invention;

FIG. 25 illustrates a front elevational view of the nozzle illustrated in FIG. 24;

FIG. 26 illustrates a sectional side elevational view of the nozzle illustrated in FIGS. 24-25, taken generally along section lines 26-26 of FIG. 25;

FIG. 27 illustrates an enlarged view of a detail of FIG. 26;

FIG. 28 illustrates a plan view of the nozzle illustrated in FIGS. 24-27;

FIG. 29 illustrates a side elevational view of the nozzle illustrated in FIGS. 24-28;

FIG. 30 illustrates a rear elevational view of the nozzle illustrated in FIGS. 24-29;

FIG. 31 illustrates a perspective view of a another flow divider insert constructed according to the present invention;

FIG. 32 illustrates a side elevational view of the flow divider illustrated in FIG. 31;

FIG. 33 illustrates a plan view of the flow divider illustrated in FIGS. 31-32;

FIG. 34 illustrates a front elevational view of the flow divider illustrated in FIGS. 31-33;

FIG. 35 illustrates a perspective view of a another flow divider insert constructed according to the present invention;

FIG. 36 illustrates a side elevational view of the flow divider illustrated in FIG. 35;

FIG. 37 illustrates a plan view of the flow divider illustrated in FIGS. 35-36;

FIG. 38 illustrates a front elevational view of the flow divider illustrated in FIGS. 35-37;

FIG. 39 illustrates a perspective view of another nozzle constructed according to the present invention;

FIG. 40 illustrates a front elevational view of the nozzle illustrated in FIG. 39;

FIG. 41 illustrates a sectional side elevational view of the nozzle illustrated in FIGS. 39-40, taken generally along section lines 41-41 of FIG. 40;

FIG. 42 illustrates an enlarged view of a detail of FIG. 41;

FIG. 43 illustrates a plan view of the nozzle illustrated in FIGS. 39-42;

FIG. 44 illustrates a side elevational view of the nozzle illustrated in FIGS. 39-43;

FIG. 45 illustrates a rear elevational view of the nozzle illustrated in FIGS. 39-44;

FIG. 46 illustrates a perspective view of a another flow divider insert constructed according to the present invention;

FIG. 47 illustrates a side elevational view of the flow divider illustrated in FIG. 46;

FIG. 48 illustrates a plan view of the flow divider illustrated in FIGS. 46-47;

FIG. 49 illustrates a front elevational view of the flow divider illustrated in FIGS. 46-48;

FIG. 50 illustrates a perspective view of a another flow divider insert constructed according to the present invention;

FIG. 51 illustrates a side elevational view of the flow divider illustrated in FIG. 50;

FIG. 52 illustrates a plan view of the flow divider illustrated in FIGS. 50-51;

FIG. 53 illustrates a front elevational view of the flow divider illustrated in FIGS. 50-52;

FIG. 54 illustrates a perspective view of a another flow divider insert constructed according to the present invention;

FIG. 55 illustrates a side elevational view of the flow divider illustrated in FIG. 54;

FIG. 56 illustrates a plan view of the flow divider illustrated in FIGS. 54-55;

FIG. 57 illustrates a front elevational view of the flow divider illustrated in FIGS. 54-56;

FIG. 58 illustrates a perspective view of a another flow divider insert constructed according to the present invention;

FIG. 59 illustrates a side elevational view of the flow divider illustrated in FIG. 58;

FIG. 60 illustrates a plan view of the flow divider illustrated in FIGS. 58-59;

FIG. 61 illustrates a front elevational view of the flow divider illustrated in FIGS. 58-60;

FIG. 62 illustrates a perspective view of a nozzle body for receiving a flow divider constructed according to the invention, and for being received in a nozzle constructed according to the invention;

FIG. 63 illustrates a rear elevational view of the nozzle body illustrated in FIG. 62;

FIG. 64 illustrates a sectional side elevational view of the nozzle body illustrated in FIGS. 62-63, taken generally along section lines 64-64 of FIG. 63;

FIG. 65 illustrates a side elevational view of the nozzle body illustrated in FIGS. 62-64;

FIG. 66 illustrates a perspective view of another nozzle constructed according to the invention;

FIG. 67 illustrates a rear elevational view of the nozzle body illustrated in FIG. 66;

FIG. 68 illustrates a sectional side elevational view of the nozzle illustrated in FIGS. 66-67, taken generally along section lines 68-68 of FIG. 67;

FIG. 69 illustrates a side elevational view of the nozzle body illustrated in FIGS. 66-68;

FIG. 70 illustrates a perspective view of another nozzle constructed according to the invention;

FIG. 71 illustrates a rear elevational view of the nozzle body illustrated in FIG. 70;

FIG. 72 illustrates a sectional side elevational view of the nozzle illustrated in FIGS. 70-71, taken generally along section lines 72-72 of FIG. 71;

FIG. 73 illustrates a side elevational view of the nozzle body illustrated in FIGS. 70-72;

FIG. 74 illustrates a perspective view of a another flow divider insert constructed according to the present invention;

FIG. 75 illustrates a side elevational view of the flow divider illustrated in FIG. 74;

FIG. 76 illustrates a plan view of the flow divider illustrated in FIGS. 74-75;

FIG. 77 illustrates a front elevational view of the flow divider illustrated in FIGS. 74-76;

FIG. 78 illustrates a perspective view of a another flow divider insert constructed according to the present invention;

FIG. 79 illustrates a side elevational view of the flow divider illustrated in FIG. 78;

FIG. 80 illustrates a plan view of the flow divider illustrated in FIGS. 78-79;

FIG. 81 illustrates a front elevational view of the flow divider illustrated in FIGS. 78-80;

FIG. 82 illustrates a perspective view of another nozzle constructed according to the invention;

FIG. 83 illustrates a rear elevational view of the nozzle body illustrated in FIG. 82;

FIG. 84 illustrates a sectional side elevational view of the nozzle illustrated in FIGS. 82-83, taken generally along section lines 84-84 of FIG. 83;

FIG. 85 illustrates a side elevational view of the nozzle body illustrated in FIGS. 82-84;

FIG. 86 illustrates a perspective view of another nozzle constructed according to the invention;

FIG. 87 illustrates a rear elevational view of the nozzle body illustrated in FIG. 86;

FIG. 88 illustrates a sectional side elevational view of the nozzle illustrated in FIGS. 86-87, taken generally along section lines 88-88 of FIG. 87;

FIG. 89 illustrates a side elevational view of the nozzle body illustrated in FIGS. 86-88;

FIG. 90 illustrates a plan view of the nozzle body illustrated in FIGS. 86-89; and,

FIG. 91 illustrates a front elevational view of the nozzle body illustrated in FIGS. 86-90.

### DETAILED DESCRIPTION OF THE ILLUSTRATIVE EMBODIMENTS

A device constructed according to the present invention includes a flow divider and an outer nozzle body. The flow divider splits a fluid stream (8 illustrated diagrammatically in FIG. 82), usually from the body of a device sometimes referred to as a gun (10 illustrated fragmentarily in FIG. 82), into two distinct flows, then recombines them at the outer nozzle body's orifice at a prescribed angle to form a flat sheet of fluid, forming a coarse, flat spray pattern (12 in FIG. 82) for spraying onto, for example, a surface (14 illustrated fragmentarily in FIG. 82) of a mold or the like in the process of forming an article (16 illustrated fragmentarily in FIG. 82) having a surface configured complementarily to the surface 14. The invention thus provides a simple and inexpensive method to provide a low-pressure, coarse, flat spray pattern with relatively narrow distribution of sprayed particle sizes. This is accomplished with a relatively small number of relatively easily manufactured parts. Instead of manufacturing a large number of discrete nozzles with distinct orifice and angle combinations, the desired spray angle is provided by the included angle of the surfaces of the flow divider. The flow divider is constructed from a blank with flats milled, ground or otherwise provided, with an appropriate included angle. The outer nozzle body provides the orifice size. A larger, single orifice, which may be, for example, generally circular, generally oval, generally cat's eye shaped, or slot shaped, is provided in the outer nozzle body, so alignment is maintained.

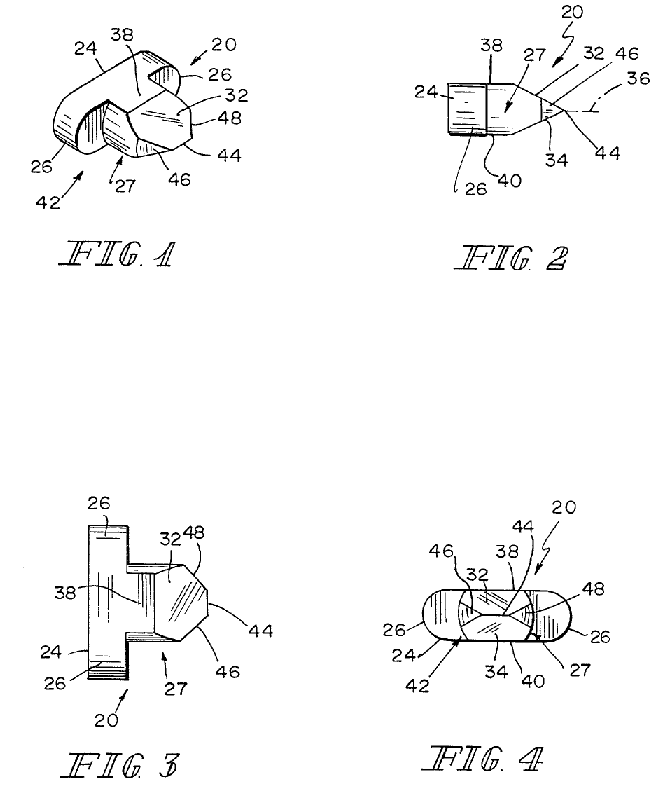

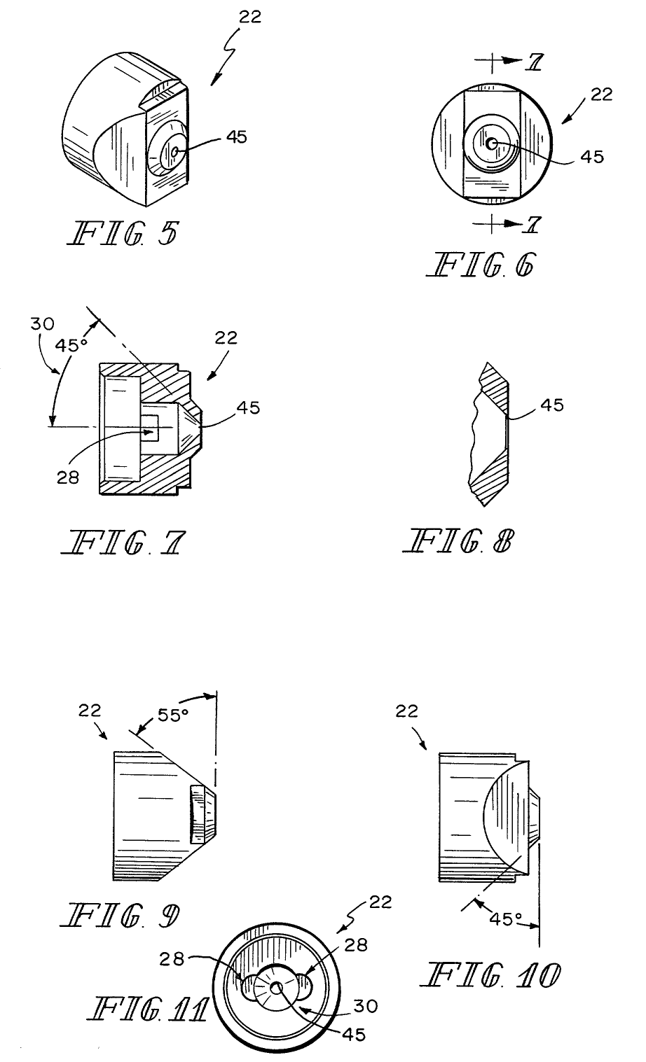

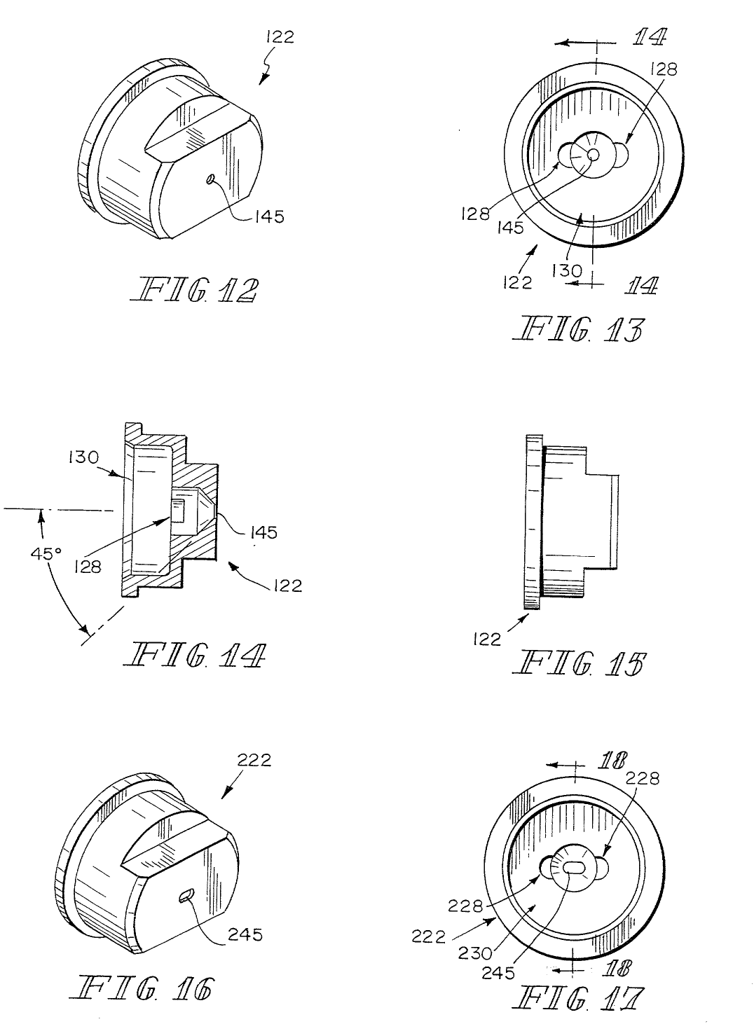

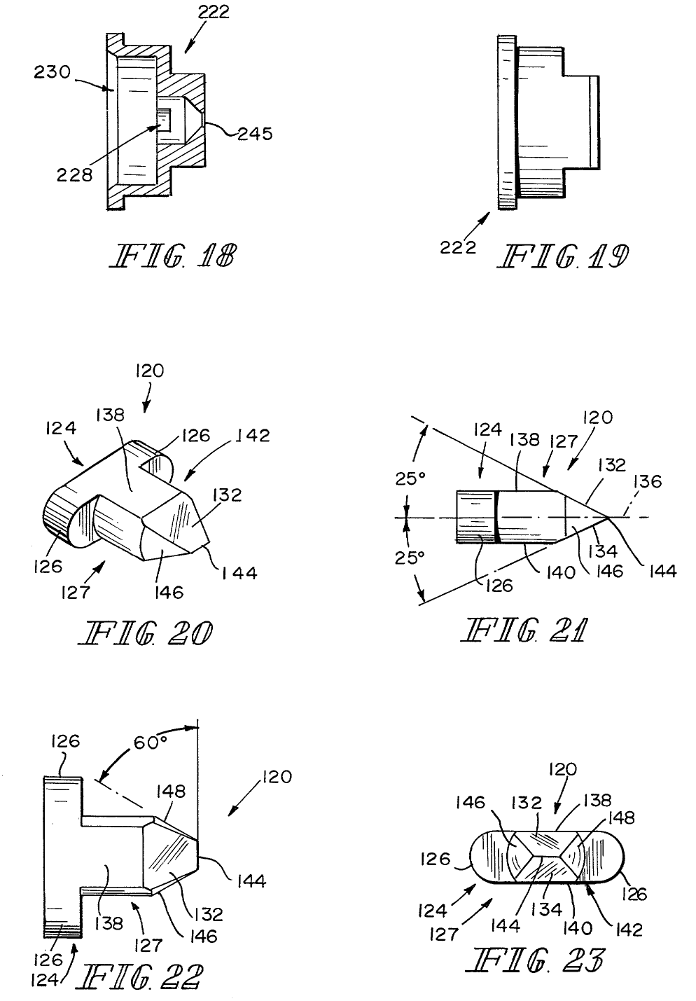

Referring now to FIGS. 1-4, a first flow divider 20 for use with nozzles 22, 122, 222 of the general type illustrated in FIGS. 5-11, 12-15 or 16-19 includes an elongated rear region 24 with arcuate ends 26 and a forwardly extending impingement body region 27. The elongated rear region 24 is configured to fit with relatively close tolerance into a complementarily configured slot 28, 128, 228 provided therefor in the back side, or inside, 30, 130, 230 of a nozzle 22, 122, 222. The impingement body region 27 is generally part right circular cylindrical when viewed from the front. When viewed in side elevation, the two surfaces 32, 34 which guide the impinging streams of material to be sprayed are evident. Surfaces 32, 34 extend at equal angles of 25° to an axis 36 of flow divider 20 and to flat surfaces 38, 40 which bound the sector 42 of the right circular cylinder which forms the bulk of impingement body region 27, and along which the divided streams of material to be sprayed flow forward toward impingement at the junction 44 of surfaces 32, 34 in the orifice 45, 145, 245 of the nozzle 22, 122, 222. This junction 44 is bounded by chamfers 46, 48 which are provided at angles of, for example, 45° to the axis 36 of flow divider 20.

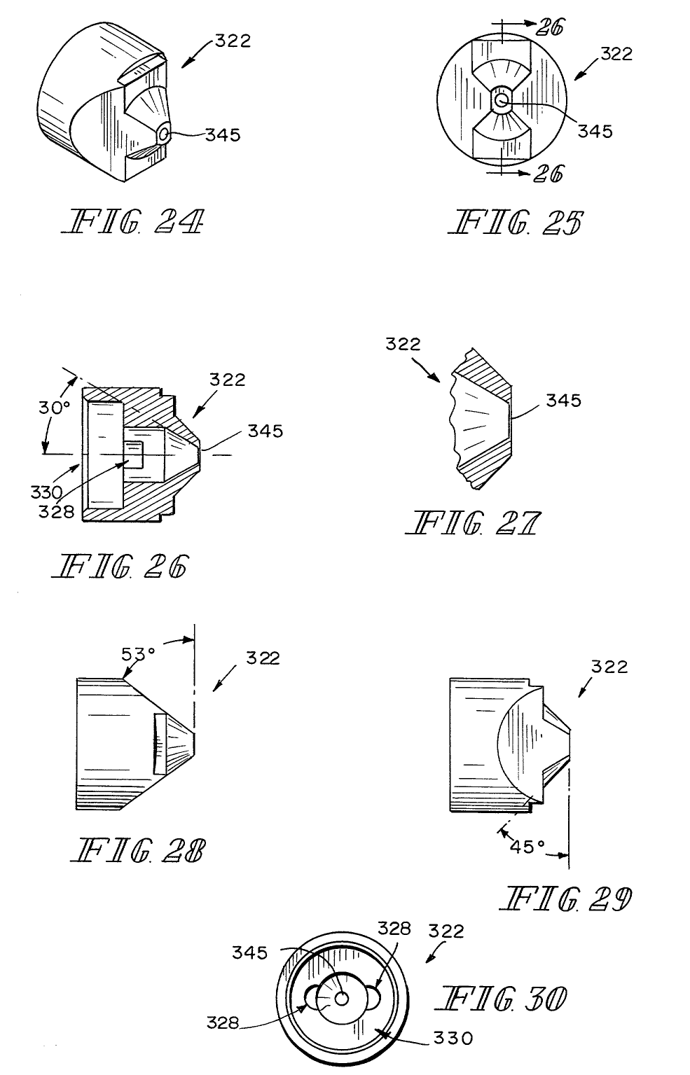

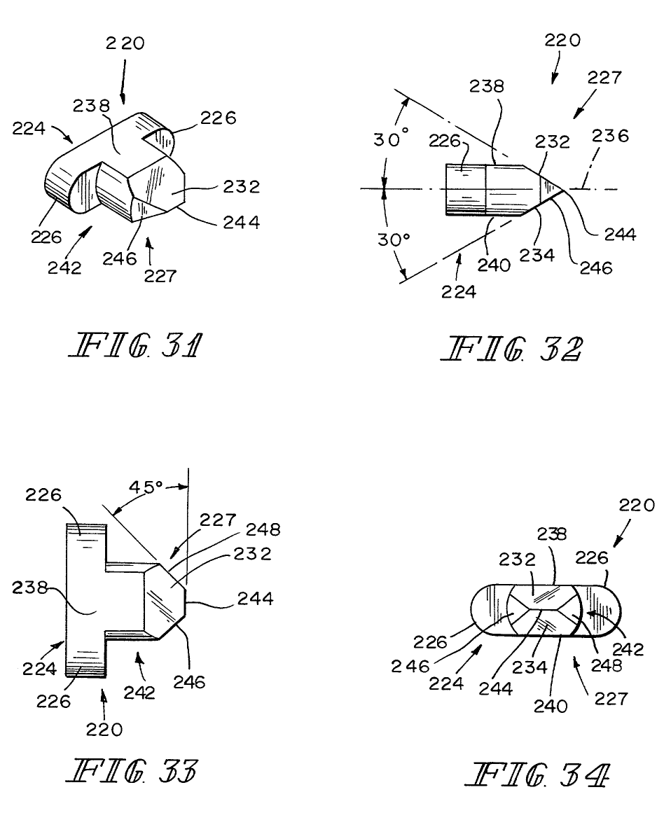

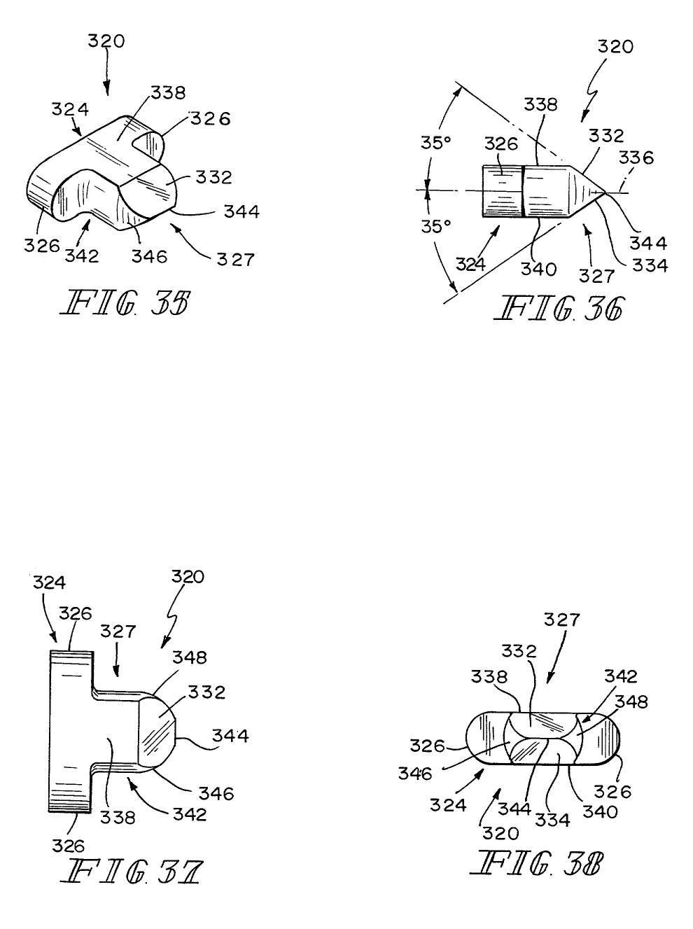

Referring now to FIGS. 20-23, a second flow divider 120 for use with nozzles 322 of the general type illustrated in FIGS. 24-30 includes an elongated rear region 124 with arcuate ends 126 and a forwardly extending impingement body region 127. The elongated rear region 124 is configured to fit with relatively close tolerance into a complementarily configured slot 328 provided therefor in the back side, or inside, 330 of nozzle 322. The impingement body region 127 is generally part right circular cylindrical when viewed from the front. When viewed in side elevation, the two surfaces 132, 134 which guide the impinging streams of material to be sprayed are evident. Surfaces 132, 134 extend at equal angles of 25° to an axis 136 of flow divider 120 and to flat surfaces 138, 140 which bound the sector 142 of the right circular cylinder which forms the bulk of impingement body region 127, and along which the divided streams of material to be sprayed flow forward toward impingement at the junction 144 of surfaces 132, 134 in the orifice 345 of the nozzle 322. This junction 144 is bounded by somewhat frustoconically shaped surfaces 146, 148 which are provided at angles of, for example, 30° to the axis 136 of flow divider 120.

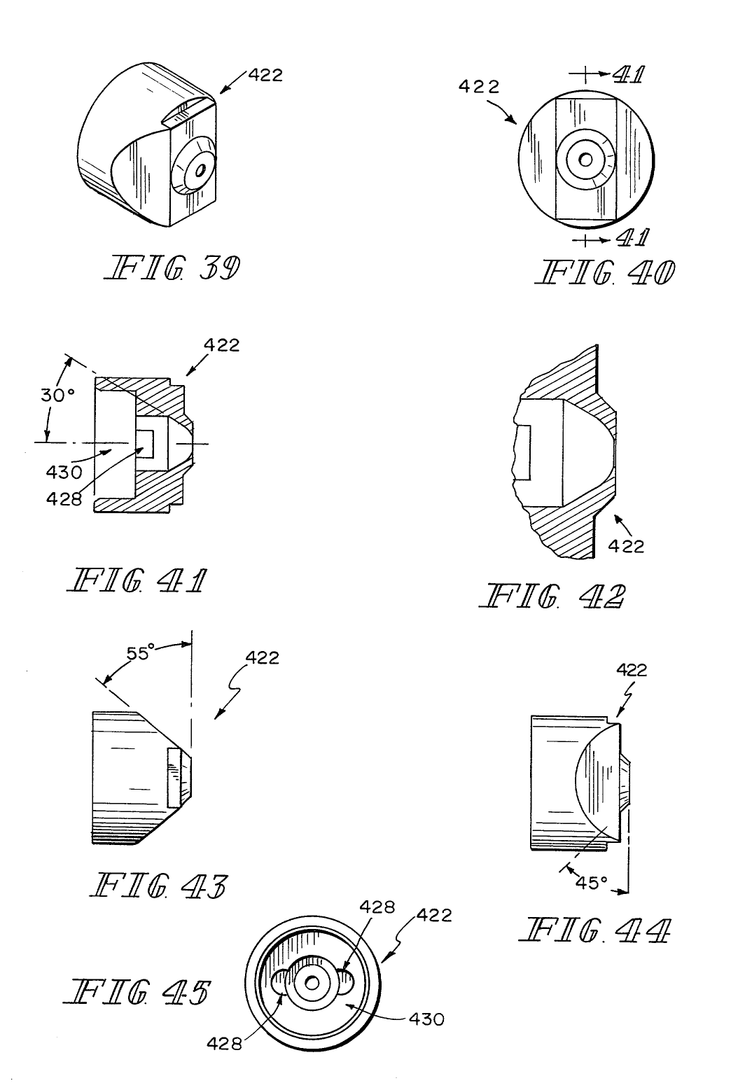

Referring now to FIGS. 31-34, a third flow divider 220 for use with nozzles 22, 122, 222 of the general type illustrated in FIGS. 5-11, 12-15 or 16-19 includes an elongated rear region 224 with arcuate ends 226 and a forwardly extending impingement body region 227. The elongated rear region 224 is configured to fit with relatively close tolerance into a complementarily configured slot 28, 128, 228 provided therefor in the back side 30, 130, 230 of a nozzle 22, 122, 222. The impingement body region 227 is generally part right circular cylindrical when viewed from the front. When viewed in side elevation, the two surfaces 232, 234 which guide the impinging streams of material to be sprayed are evident. Surfaces 232, 234 extend at equal angles of 30° to an axis 236 of flow divider 220 and to flat surfaces 238, 240 which bound the sector 242 of the right circular cylinder which forms the bulk of impingement body region 227, and along which the divided streams of material to be sprayed flow forward toward impingement at the junction 244 of surfaces 232, 234 in the orifice 45, 145, 245 of the nozzle 22, 122, 222. This junction 244 is bounded by somewhat frustoconically shaped surfaces 246, 248 which are provided at angles of, for example, 45° to the axis 236 of flow divider 220.

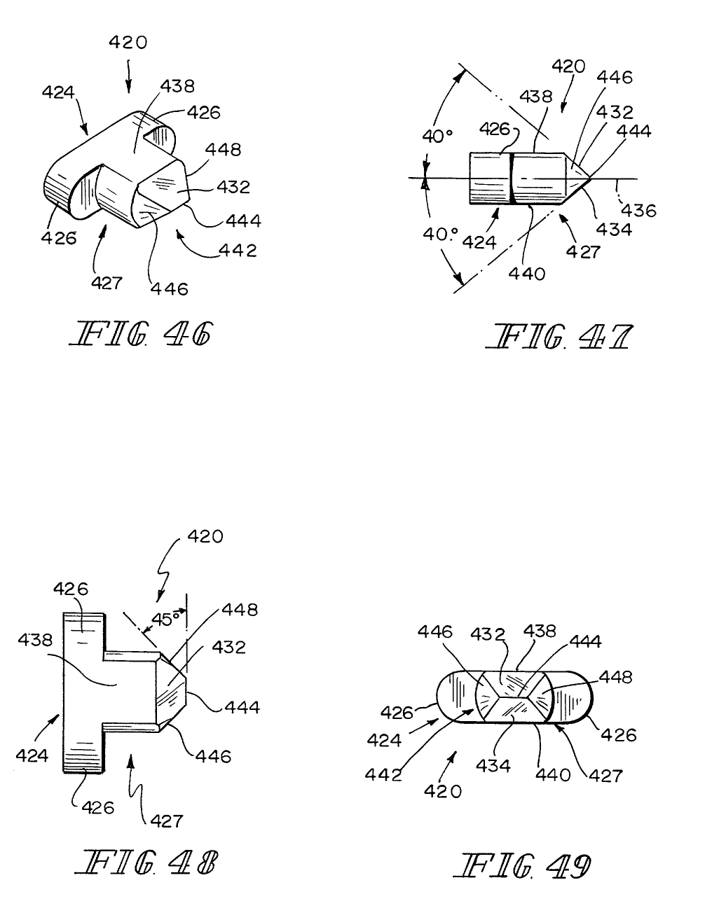

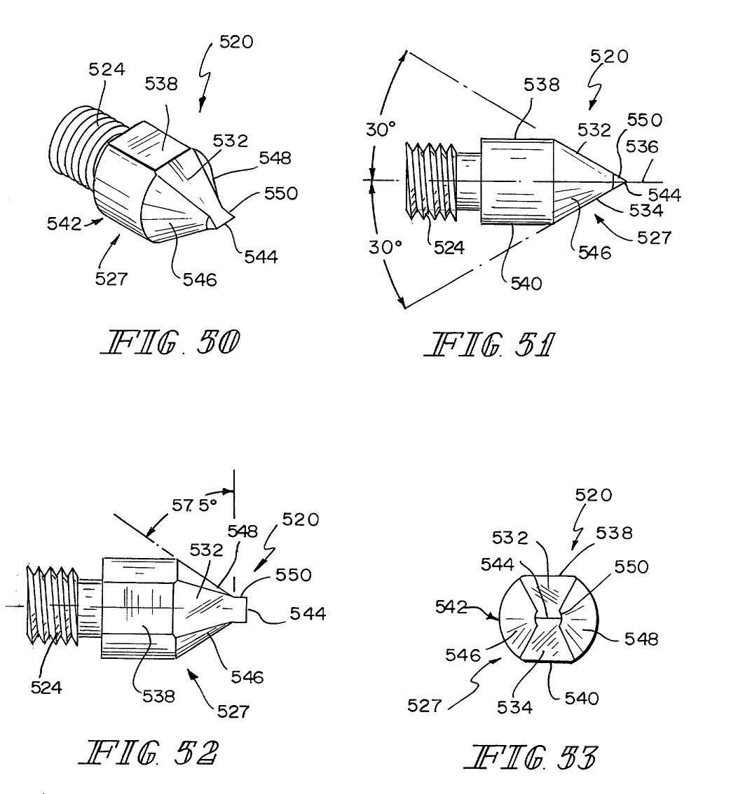

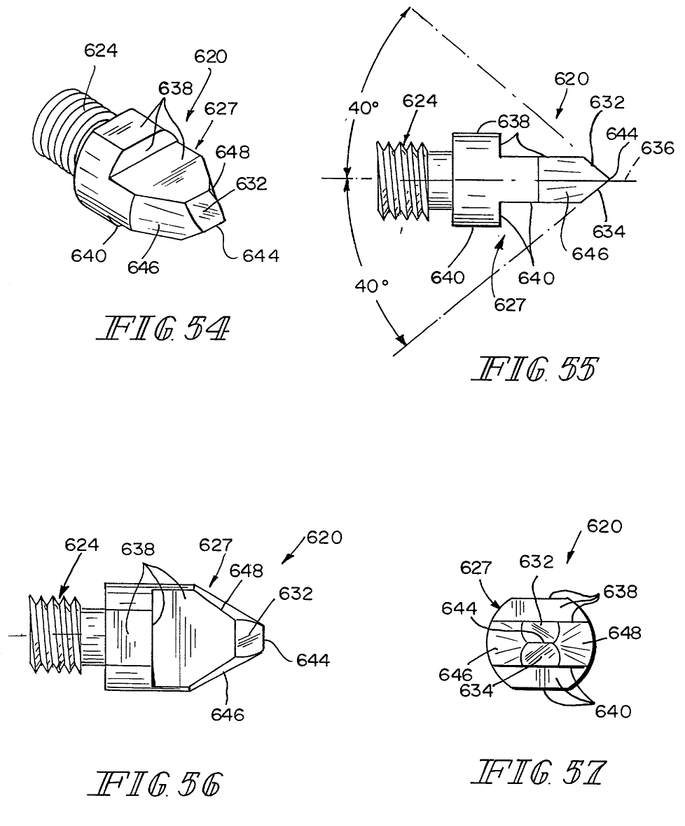

Referring now to FIGS. 35-38, a fourth flow divider 320 for use with nozzles 422 of the general type illustrated in FIGS. 39-45 includes an elongated rear region 324 with arcuate ends 326 and a forwardly extending impingement body region 327. The elongated rear region 324 is configured to fit with relatively close tolerance into a complementarily configured slot 428 provided therefor in the back side, or inside, 430 of nozzle 422. The impingement body region 327 is generally part right circular cylindrical when viewed from the front. When viewed in side elevation, the two surfaces 332, 334 which guide the impinging streams of material to be sprayed are evident. Surfaces 332, 334 extend at equal angles of 35° to an axis 336 of flow divider 320 and to flat surfaces 338, 340 which bound the sector 342 of the right circular cylinder which forms the bulk of impingement body region 327, and along which the divided streams of material to be sprayed flow forward toward impingement at the junction 344 of surfaces 332, 334 in the orifice 445 of the nozzle 422. The chamfers 46, 48, 146, 148, 246, 248 are replaced in this embodiment by arcuate features 346, 348 having radii of, for example, 3/32″ (about 2.4 mm.).

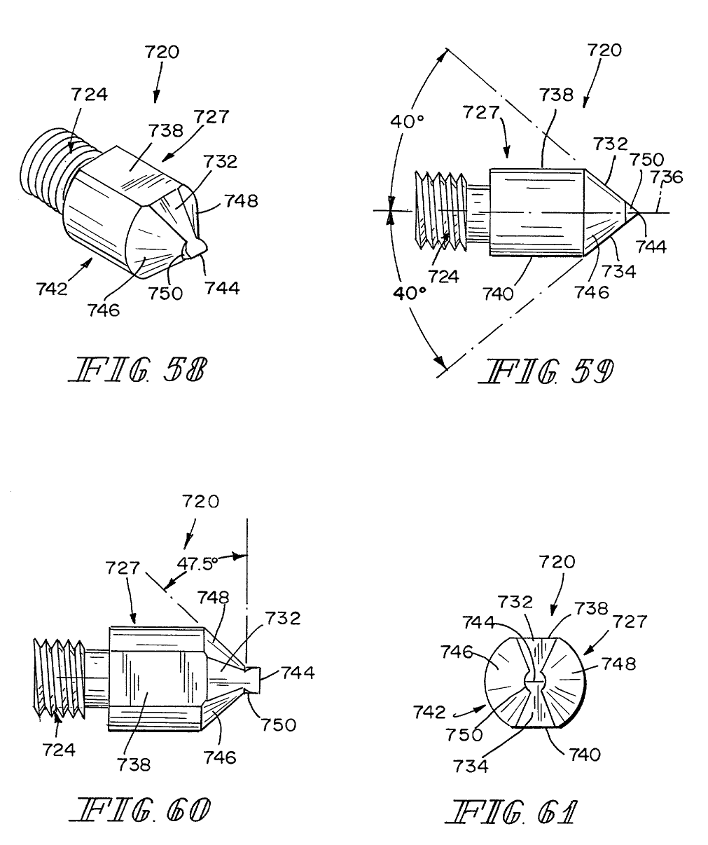

Referring now to FIGS. 46-49, a fifth flow divider 420 for use with nozzles 22, 122, 222 of the general type illustrated in FIGS. 5-11, 12-15 or 16-19 includes an elongated rear region 424 with arcuate ends 426 and a forwardly extending impingement body region 427. The elongated rear region 424 is configured to fit with relatively close tolerance into a complementarily configured slot 28, 128, 228 provided therefor in the back side 30, 130, 230 of a nozzle 22, 122, 222. The impingement body region 427 is generally part right circular cylindrical when viewed from the front. When viewed in side elevation, the two surfaces 432, 434 which guide the impinging streams of material to be sprayed are evident. Surfaces 432, 434 extend at equal angles of 40° to an axis 436 of flow divider 420 and to flat surfaces 438, 440 which bound the sector 442 of the right circular cylinder which forms the bulk of impingement body region 427, and along which the divided streams of material to be sprayed flow forward toward impingement at the junction 444 of surfaces 432, 434 in the orifice 45, 145, 245 of the nozzle 22, 122, 222. This junction 444 is bounded by somewhat frustoconically shaped surfaces 446, 448 which are provided at angles of, for example, 45° to the axis 436 of flow divider 420.

The nozzles 22, 122, 222, 322, 422 illustrated in FIGS. 5-11, 12-15, 16-19, 24-30 and 39-45 include either internal or external threads, flanges for engagement by nuts (450 illustrated in broken lines in FIG. 82), or the like, all well known in the art, for attachment to the front ends of guns, for the supply to the nozzles 22, 122, 222, 322, 422 of high pressure flows of the material to be dispensed through nozzles 22, 122, 222, 322, 422. The material to be sprayed is provided to the back sides 30, 130, 230, 330 of all of nozzles 22, 122, 222, 322, 422. As the material flows forward, it is divided into two streams by the flow divider 20, 120, 220, 320, 420. The separate flows then reconverge and impinge upon each other as they flow forward, in the region of the discharge orifice 45, 145, 245, 345, 445 of the nozzle 22, 122, 222, 322, 422.

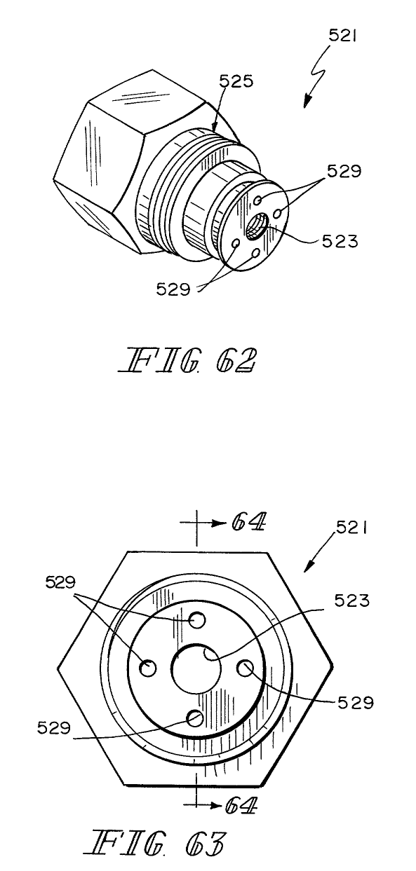

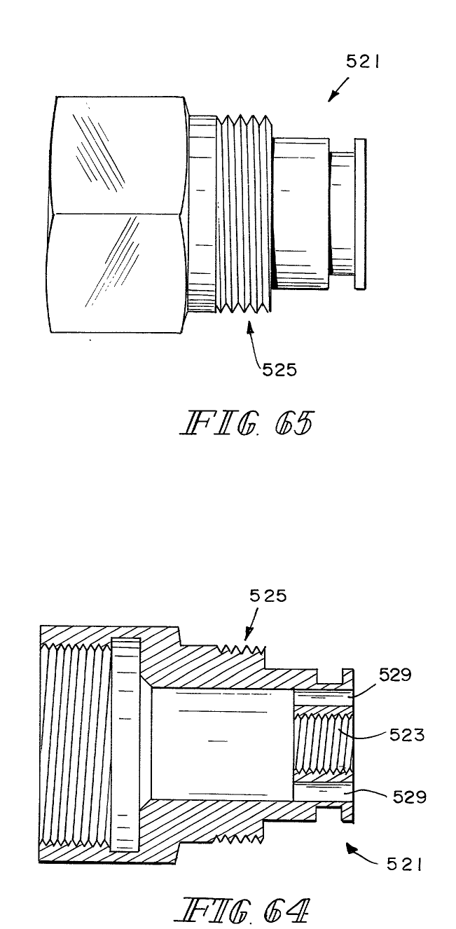

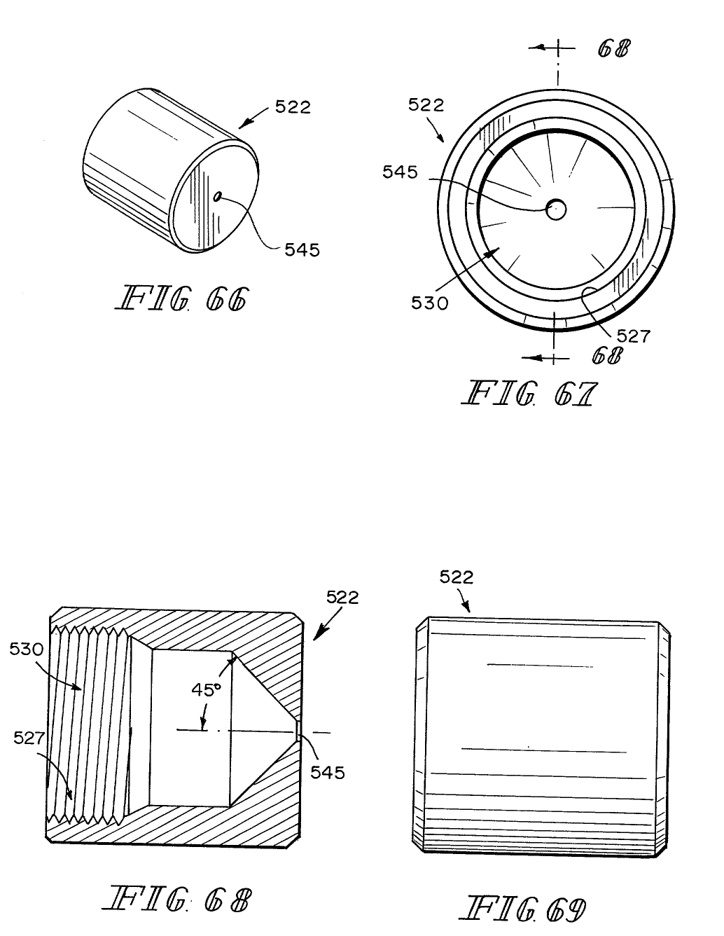

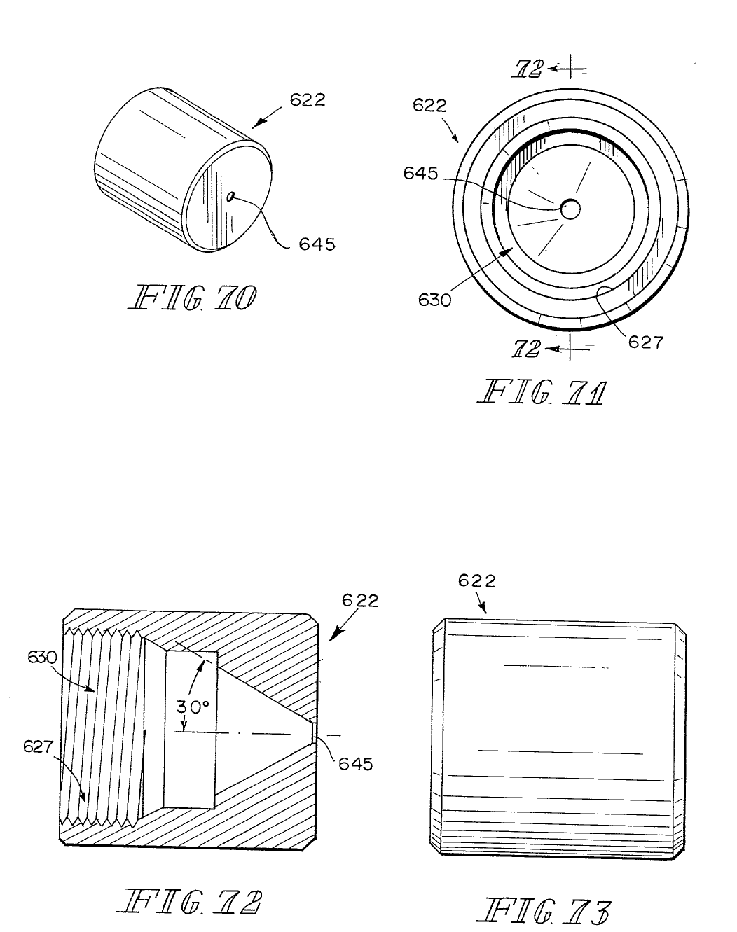

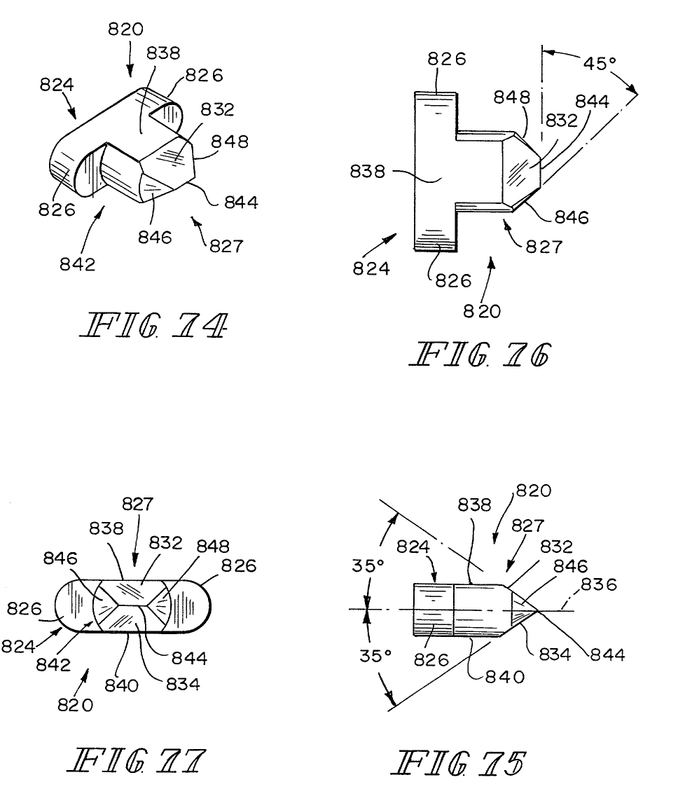

Referring now to FIGS. 50-53, a sixth flow divider 520 for use with nozzle bodies 521 of the general type illustrated in FIGS. 62-65 and nozzles 522, 622 of the general type illustrated in FIGS. 66-69 or 70-73 includes a screw threaded rear region 524 and a forwardly extending impingement body region 527. The screw threaded rear region 524 is configured to screw into a complementarily threaded region 523 of nozzle body 521. The impingement body region 527 is generally part right circular cylindrical when viewed from the front. When viewed in side elevation, the two surfaces 532, 534 which guide the impinging streams of material to be sprayed are evident. Surfaces 532, 534 extend at equal angles of 30° to an axis 536 of flow divider 520 and to flat surfaces 538, 540 which bound the sector 542 of the right circular cylinder which forms the bulk of impingement body region 527, and along which the divided streams of material to be sprayed flow forward toward impingement at the junction 544 of surfaces 532, 534 in the orifice 545, 645 of the nozzle 522, 622. This junction 544 is bounded by tapered, generally frustoconical surfaces 546, 548 which extend at angles of, for example, 32.5° to the axis 536 of flow divider 520, and terminate at a tip 550 which is at least partly right circular cylindrical when viewed from the front and complementarily sized to fit within orifice 545, 645.

Referring now to FIGS. 54-57, a seventh flow divider 620 for use with nozzle bodies 521 of the general type illustrated in FIGS. 62-65 and nozzles 522, 622 of the general type illustrated in FIGS. 66-69 or 70-73 includes a screw threaded rear region 624 and a forwardly extending impingement body region 627. The screw threaded rear region 624 is configured to screw into complementarily threaded region 523 of nozzle body 521. The impingement body region 627 is generally part right circular cylindrical when viewed from the front. When viewed in side elevation, the two surfaces 632, 634 which guide the impinging streams of material to be sprayed are evident. Surfaces 632, 634 extend at equal angles of 40° to an axis 636 of flow divider 620. Flat surfaces 638, 640 bound the sector 642 of the right circular cylinder which forms the bulk of impingement body region 627. The divided streams of material to be sprayed flow forward along surfaces 638, 640 toward impingement at the junction 644 of surfaces 632, 634 in the orifice of the nozzle 522, 622. This junction 644 is bounded by tapered, generally frustoconical surfaces 646, 648 which are provided at angles of, for example, 30° to the axis 636 of flow divider 620.

Referring now to FIGS. 58-61, an eighth flow divider 720 for use with nozzle bodies 521 of the general type illustrated in FIGS. 62-65 and nozzles 522, 622 of the general type illustrated in FIGS. 66-69 or 70-73 includes a screw threaded rear region 724 and a forwardly extending impingement body region 727. The screw threaded rear region 724 is configured to screw into complementarily threaded region 523 of nozzle body 521. The impingement body region 727 is generally part right circular cylindrical when viewed from the front. When viewed in side elevation, the two surfaces 732, 734 which guide the impinging streams of material to be sprayed are evident. Surfaces 732, 734 extend at equal angles of 40° to an axis 736 of flow divider 720 and to flat surfaces 738, 740 which bound the sector 742 of the right circular cylinder which forms the bulk of impingement body region 727, and along which the divided streams of material to be sprayed flow forward toward impingement at the junction 744 of surfaces 732, 734 in the orifice of the nozzle 522, 622. This junction 744 is bounded by tapered, generally frustoconical surfaces 746, 748 which extend at angles of, for example, 42.5° to the axis 736 of flow divider 720, and terminate at a tip 750 which is at least partly right circular cylindrical when viewed from the front and complementarily sized to fit within orifice 545, 645.

Nozzle body 521 also includes screw threaded region 525. Nozzles 522, 622 include complementarily threaded regions 527, 627 for receiving the threads of screw threaded region 525 of nozzle body 521 to assemble the nozzle. The material to be sprayed is provided to the back sides 530, 630 of nozzles 522, 622. As the material flows forward through nozzle 522, 622 and passageways 529 provided in nozzle body 521, it is separated into two streams by the flow divider 520, 620, 720. The separated flows then impinge upon each other, reconverging at 544, 644, 744 as they flow forward, in the region of the discharge orifice 545, 645 of the nozzle 522, 622.

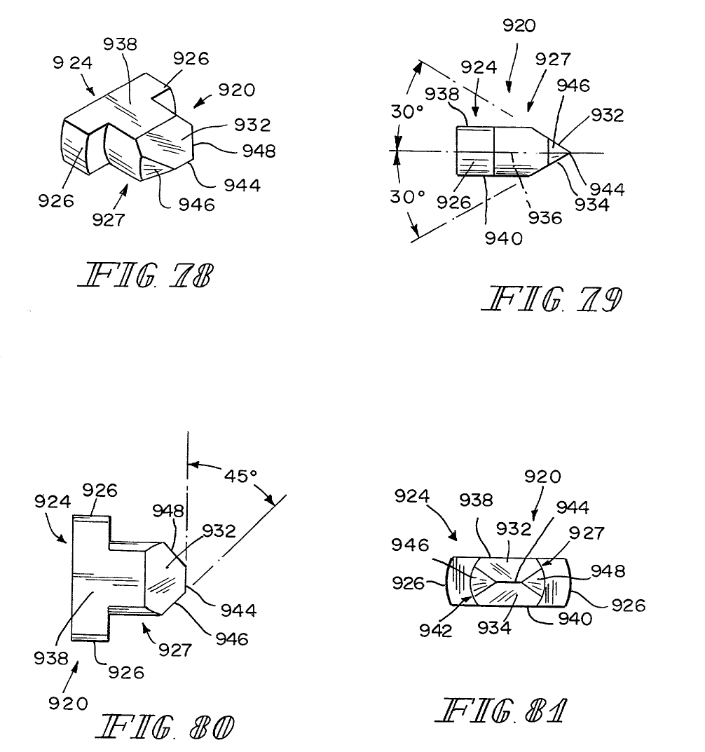

Referring now to FIGS. 74-77, a ninth flow divider 820 for use with nozzles 22, 122, 222 of the general type illustrated in FIGS. 5-11, 12-15 or 16-19 includes an elongated rear region 824 with arcuate ends 826 and a forwardly extending impingement body region 827. The elongated rear region 824 is configured to fit with relatively close tolerance into a complementarily configured slot 28, 128, 228 provided therefor in the back side 30, 130, 230 of a nozzle 22, 122, 222. The impingement body region 827 is generally part right circular cylindrical when viewed from the front. When viewed in side elevation, the two surfaces 832, 834 which guide the impinging streams of material to be sprayed are evident. Surfaces 832, 834 extend at equal angles of 35° to an axis 836 of flow divider 820 and to flat surfaces 838, 840 which bound the sector 842 of the right circular cylinder which forms the bulk of impingement body region 827, and along which the divided streams of material to be sprayed flow forward toward impingement at the junction 844 of surfaces 832, 834 in the orifice 45, 145, 245 of the nozzle 22, 122, 222. This junction 844 is bounded by somewhat frustoconically shaped surfaces 846, 848 which are provided at angles of, for example, 45° to the axis 836 of flow divider 820.

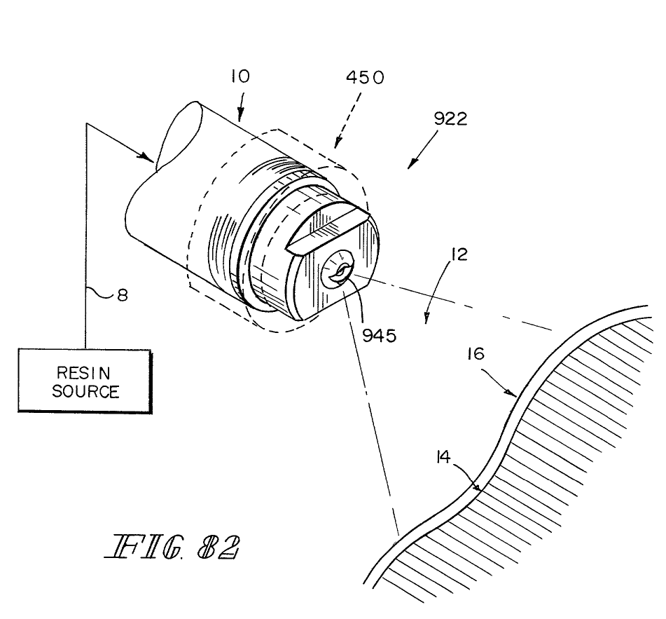

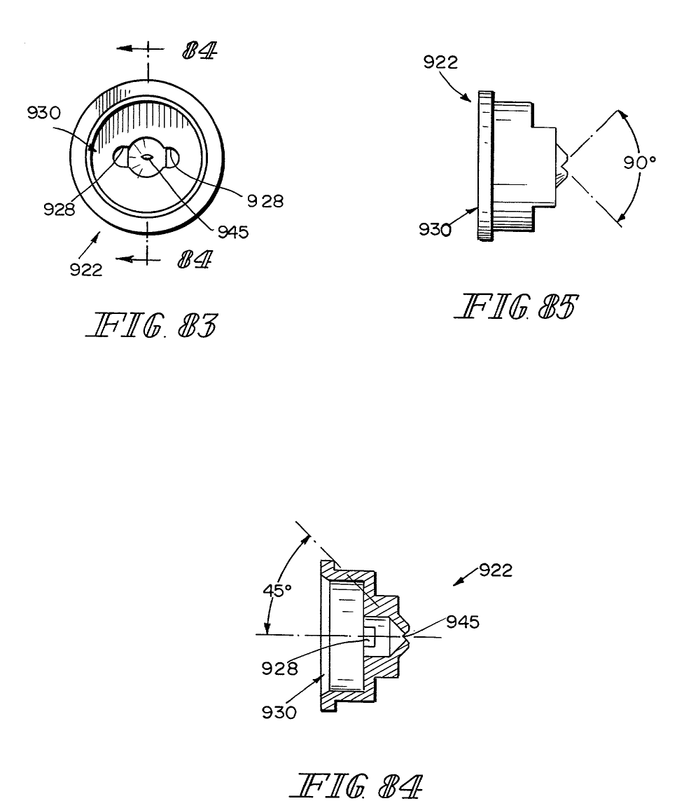

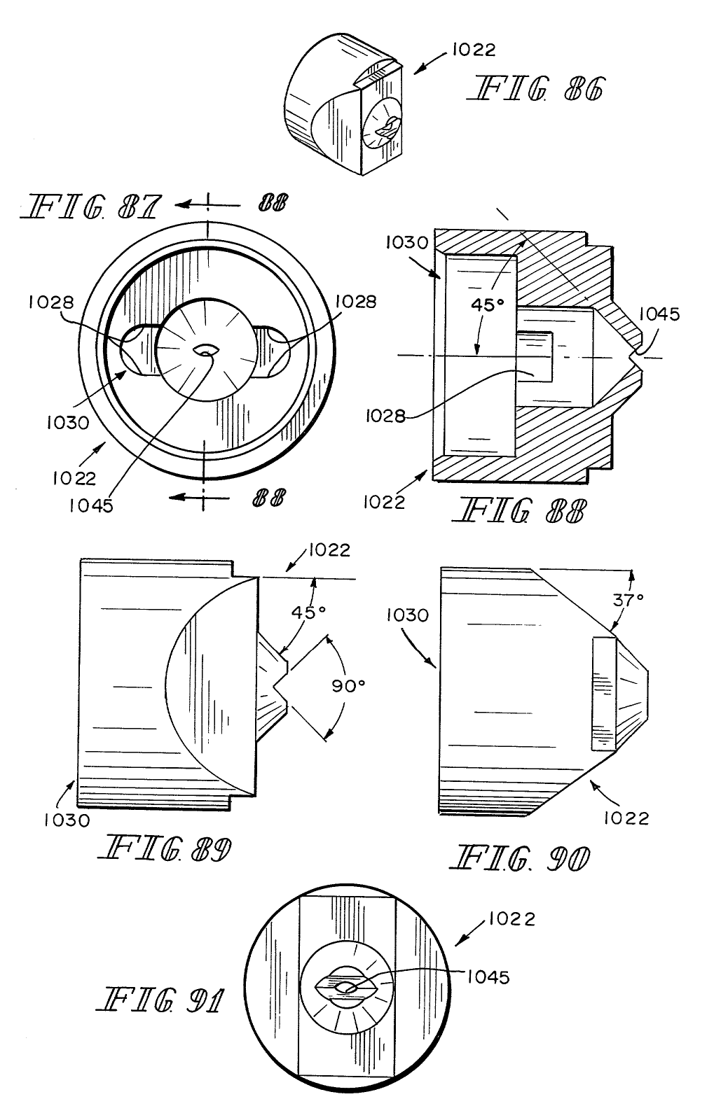

Referring now to FIGS. 78-81, a tenth flow divider 920 for use with nozzles 922, 1022 of the general type illustrated in FIGS. 82-85 or 86-91, respectively, includes an elongated rear region 924 with arcuate ends 926 and a forwardly extending impingement body region 927. The elongated rear region 924 is configured to fit with relatively close tolerance into a complementarily configured slot 928, 1028, respectively, provided therefor in the back side 930, 1030, respectively, of nozzle 922, 1022. The impingement body region 927 is generally part right circular cylindrical when viewed from the front. When viewed in side elevation, the two surfaces 932, 934 which guide the impinging streams of material to be sprayed are evident. Surfaces 932, 934 extend at equal angles of 30° to an axis 936 of flow divider 920 and to flat surfaces 938, 940 which bound the sector 942 of the right circular cylinder which forms the bulk of impingement body region 927, and along which the divided streams of material to be sprayed flow forward toward impingement at the junction 944 of surfaces 932, 934 in the orifice 945 or 1045 of the nozzle 922 or 1022, respectively. This junction 944 is bounded by somewhat frustoconically shaped surfaces 946, 948 which are provided at angles of, for example, 45° to the axis 936 of flow divider 920.

The nozzles 922, 1022 illustrated in FIGS. 82-85 and 86-91 include either internal or external threads, flanges for engagement by nuts, or the like, all well known in the art, for attachment to the front ends of guns for the supply to the nozzles 922, 1022 of high pressure flows of the material to be dispensed through nozzles 922, 1022. The material to be sprayed is provided to the back sides 930, 1030 of nozzles 922, 1022, respectively. As the material flows forward, it is divided into two streams by the flow divider, for example, flow divider 920. The separate flows then reconverge and impinge upon each other as they flow forward, in the region of the discharge orifice 945, 1045 of the nozzle 922, 1022, respectively.

The nozzles 22, 122, 222, 322, 422, 922, 1022 can be constricted from any suitable materials. For example, the bodies of these devices can be constructed from aluminum, stainless steel, or the like, treated to reduce the effects of wear or with wear inserts of, for example, tool steel or tungsten carbide, in areas subject to greater wear, such as surfaces 32, 34, 132, 134, 232, 234, 332, 334, 432, 434, 532, 534, 632, 634, 732, 734, 832, 834, 932, 934, and around orifices 45, 145, 245, 345, 445, 545, 645, 945, 1045.

What is claimed is:

1. Apparatus for dispensing a fluid, the apparatus including a nozzle defining an orifice in a front face of the nozzle, through which orifice the material is discharged, the nozzle including a flow divider cooperating to separate a supply of the material into two streams, the flow divider including two surfaces which intersect not further forward in the nozzle than the front face.

2. The apparatus of claim 1 wherein the nozzle includes a first feature and the flow divider is formed as a separate component including a second feature cooperating with the first feature to orient the intersection of the two surfaces with respect to the orifice.

3. The apparatus of claim 2 wherein the first feature includes a relief formed in a back side of the front face, and the second feature includes a region of the flow divider for orientation in the relief.

4. The apparatus of claim 1 wherein the two surfaces include two flat surfaces.

5. The apparatus of claim 4 wherein the nozzle includes a first feature and the flow divider is formed as a separate component including a second feature cooperating with the first feature to orient the intersection of the two surfaces with respect to the orifice.

6. The apparatus of claim 5 wherein the first feature includes a relief formed in a back side of the front face, and the second feature includes a region of the flow divider for orientation in the relief.

7. The apparatus of claim 1 wherein adjacent the orifice the two surfaces make substantially equal angles to a longitudinal axis of the nozzle.

8. The apparatus of claim 7 wherein the nozzle includes a first feature and the flow divider is formed as a separate component including a second feature cooperating with the first feature to orient the intersection of the two surfaces with respect to the orifice.

9. The apparatus of claim 8 wherein the first feature includes a relief formed in a back side of the front face, and the second feature includes a region of the flow divider for orientation in the relief.

10. The apparatus of claim 8 wherein the angles are between 20 and 60 degrees.

11. The apparatus of claim 10 wherein the angles are between 25 and 40 degrees.

12. The apparatus of claim 7 wherein the angles are between 20 and 60 degrees.

13. The apparatus of claim 12 wherein the angles are between 25 and 40 degrees.

14. The apparatus of claim 1 wherein the orifice is generally circular transverse to an axis of the nozzle.

15. The apparatus of claim 2 wherein the orifice is generally circular transverse to an axis of the nozzle.

16. The apparatus of claim 3 wherein the orifice is generally circular transverse to an axis of the nozzle.

17. The apparatus of claim 4 wherein the orifice is generally circular transverse to an axis of the nozzle.

18. The apparatus of claim 7 wherein the orifice is generally circular transverse to an axis of the nozzle.

19. The apparatus of claim 10 wherein the orifice is generally circular transverse to an axis of the nozzle.

20. The apparatus of claim 11 wherein the orifice is generally circular transverse to an axis of the nozzle.

21. The apparatus of claim 1 wherein the orifice is generally cat's eye shaped transverse to an axis of the nozzle.

22. The apparatus of claim 2 wherein the orifice is generally cat's eye shaped transverse to an axis of the nozzle.

23. The apparatus of claim 3 wherein the orifice is generally cat's eye shaped transverse to an axis of the nozzle.

24. The apparatus of claim 4 wherein the orifice is generally cat's eye shaped transverse to an axis of the nozzle.

25. The apparatus of claim 7 wherein the orifice is generally cat's eye shaped transverse to an axis of the nozzle.

26. The apparatus of claim 10 wherein the orifice is generally cat's eye shaped transverse to an axis of the nozzle.

27. The apparatus of claim 11 wherein the orifice is generally cat's eye shaped transverse to an axis of the nozzle.

28. A method of dispensing a fluid, the method including impinging separate streams of the fluid against each other, and substantially simultaneously ejecting the reunited stream through an orifice.

29. The method of claim 28 further including dividing a flow of the fluid into the separate streams using a flow divider, impinging the streams against each other including impinging the streams against each other at a downstream end of the flow divider.

30. The method of claim 29 wherein impinging the streams against each other at a downstream end of the flow divider includes providing on the flow divider separate surfaces across which the separate streams flow downstream from a point at which the flow divider divides the fluid into separate streams, the separate surfaces intersecting each other no further downstream in the flow of the fluid than the orifice.

31. An article made by impinging separate streams of a fluid against each other, and substantially simultaneously ejecting the reunited stream formed from the impinging streams through an orifice.

32. The article of claim 31 made by dividing a curable fluid into the separate streams, impinging the streams against each other, substantially simultaneously ejecting the reunited streams through an orifice onto a surface having a complementary shape to a shape of the article, permitting the fluid to cure on the complementarily shaped surface, and removing the article from the surface.

33. The article of claim 31 made by dividing the fluid into separate streams using a flow divider, and impinging the streams against each other at a downstream end of the flow divider.

34. The article of claim 33 made by providing on the flow divider separate surfaces across which the separate streams flow downstream from a point at which the flow divider divides the fluid into separate streams, the separate surfaces intersecting each other no further downstream in the flow of the fluid than the orifice.

35. Apparatus for dispensing a fluid, the apparatus including means for dividing a flow of fluid into separate streams, means for impinging the separate streams against each other, and means for substantially simultaneously ejecting the reunited stream through an orifice.

36. The apparatus of claim 35 wherein the means for dividing the fluid into separate streams includes a flow divider, and the means for impinging the streams against each other includes impingement means at a downstream end of the flow divider.

37. The method of claim 36 wherein the impingement means includes separate surfaces which intersect each other no further downstream in the flow of the fluid than the orifice.
